(19) United States
(12) Patent Application Publication
(10) Pub. No.: US 2026/0061533 A1
(43) Pub. Date: Mar. 5, 2026

(54) TOOL POST FOR MACHINE TOOLS

(71) Applicant: OKUMA CORPORATION, Niwa-gun (JP)

(72) Inventors: Satoshi Ohno, Niwa-gun (JP); Makoto Kajino, Niwa-gun (JP); Katsunari Kito, Niwa-gun (JP)

(73) Assignee: OKUMA CORPORATION, Niwa-gun (JP)

(21) Appl. No.: 19/316,103

(22) Filed: Sep. 2, 2025

(30) Foreign Application Priority Data
Sep. 2, 2024 (JP) 2024-150637

(51) Int. Cl. B23Q 1/00; B23Q 3/157

(52) U.S. Cl. CPC B23Q 1/0009; B23Q 3/15722

(57) ABSTRACT

Provided is a tool post for machine tools, which is capable of mounting, on a turret, an actuator that is driven by forces of various fluids, such as hydraulic oil, air, and coolant, without an increase in size of the turret. On each of tool holder mounting surfaces 11 of a turret 2, ends 23a and 42a of a plurality of fluid connection passages 23 and 42 configured to allow supply of fluid are made open. The turret 2 and a tool post body 3 are provided with fluid supply mechanisms 20 and 40 configured to supply fluid to the fluid connection passages 23 and 42, respectively. An actuator, which uses fluid supplied through each of the fluid connection passages 23 and 42 as a driving source, is configured to be mountable on the turret 2.

### TECHNICAL FIELD

The present invention relates to a tool post provided to machine tools, for example, NC lathes.

### BACKGROUND ART

A conventional tool post has a rotary indexing turret capable of mounting a plurality of tools (including tool holders), and constitutes a main structural unit of NC lathes that perform cutting on a workpiece into various shapes while indexing a required tool and causing the tool to move in the X and Z directions. Also, on each of tool holder mounting surfaces, provided is a flow passage of one nozzle channel, which nozzle ejects cutting fluid toward the cutting edge of the tool.

Such a tool post comes in two types: one dedicated to turning operations; and the other adapted for rotating (milling) tools.

In recent years, due to labor shortages, there has been a growing demand for process consolidation and automation, and a multifunctional tool post that overcomes this problem is thus required.

For example, Patent Literature 1 discloses a tool post equipped with a turret with which selection of a tool to be used is performed by rotary indexing of the tool post that detachably mounts a plurality of tools, and on this tool post a workpiece clamping device is detachably mounted.

In such a tool post provided with the workpiece clamping device, there has been an increasing demand for promoting automation, not only by enabling simple opening/closing of the clamping lever but also by adding a mechanism configured to perform automatic cleaning, etc. with air and coolant.

In the tool post disclosed in Patent Literature 1, in order to cause cleaning and so on to be performed, there is a need to increase the number of channels through which fluids such as air and coolant are supplied.

As a tool post that allows for increase in the number of channels through which fluids are supplied, disclosed, in Patent Literature 2, is a tool post in which a turret shaft is provided with axial through-holes that are in communication with an outer surface of the turret, and through these through holes, cutting fluid or hydraulic oil is supplied from a tool post body to the turret side.

With the tool post disclosed in Patent Literature 2, a hydraulic cylinder configured to open and close fingers of a workpiece holding device, a detector configured to confirm the movement of the fingers, and wiring and piping for air and so on to be used for cleaning rollers are provided to the workpiece holding device from the front surface side of the turret, which causes a problem that the size of the turret increases.

The tool post disclosed in Patent Literature 2 is a tool post dedicated to turning operations (i.e., it cannot mount rotary tools), and therefore cannot be used as a tool post adapted for rotary tools. As such, the tool post disclosed in Patent Literature 2 is designed to be used in combination with a conventional tool post adapted for rotary tools. That is, in the tool post equipped with a turret capable of mounting rotary tools (tool holders for rotary tools), because a rotary drive shaft for rotary tools is disposed in the vicinity of the center of the tool holder mounting surface, it is difficult to increase the number of channels through which fluid is supplied, and therefore, there have conventionally been no tool posts adapted for rotary tools, which allows for an increase in the number of channels through which fluid is supplied.

### Citation List

### Patent Literature

[Patent Literature 1] Japanese Unexamined Patent Application Publication No. JP-A-2017-205832

[Patent Literature 2] Japanese Unexamined Patent Application Publication No. JP-A-2004-25403

### SUMMARY OF INVENTION

### Technical Problem

An object of the present invention, in view of the above-described circumstances, is to provide a tool post for machine tools which is capable of mounting, on a turret, an actuator that drives with the pressure of various types of fluids, such as hydraulic oil, air, and coolant, without increasing the size of the turret.

Another object of the present invention, in view of the above-described circumstances, is to provide a tool post for machine tools, the tool post adapted for rotary tools, in which a rotary drive shaft for rotary tools is disposed in the vicinity of the center of the tool holder mounting surface, which allows for an increase in the number of channels through which fluid is supplied.

### Solution to Problem

The present invention consists of the following aspects, in order to achieve the above-described objects.

1) A tool post for machine tools, the tool post including: a turret provided on an outer periphery thereof with a plurality of tool holder mounting surfaces on which a plurality of types of tool holders are mounted, the turret configured to be indexed by rotation to a designated position; and a tool post body configured to rotatably support the turret, the tool post characterized in that, on each of the tool holder mounting surfaces of the turret, one end of each of a plurality of fluid connection passages configured to allow supply of fluid is made open, and the turret and the tool post body are provided with fluid supply mechanisms configured to supply the fluid to each of the fluid connection passages, and an actuator, which uses the fluid supplied through each of the fluid connection passages as a driving source, is configured to be mountable on the turret. It should be noted that the actuator may mount components having various functions and operating by hydraulic pressure, water pressure, or pneumatic pressure, such as a rotation mechanism or a linear motion mechanism that causes a tool holder and other members to rotate or move linearly, a workpiece handling mechanism, an ATC mechanism, etc.

2) The tool post for machine tools according to the above-described aspect 1), wherein the tool post includes at least one tool holder for rotary tools, as the plurality of types of tool holders, and a rotary drive shaft for rotary tools is disposed in a vicinity of a center of the tool holder mounting surface for the tool holder for rotary tools, the plurality of fluid connection passages consist of: at least one of front-surface-side fluid connection passages; and at least one of rear-surface-side fluid connection passages, where the front-surface-side fluid connection passages and the rear-surface-side fluid connection passages are respectively opposed to each other with the rotary drive shaft for rotary tools interposed therebetween, and the fluid supply mechanisms consist of: a front-side fluid supply mechanism configured to supply fluid to the at least one of the front-surface-side fluid connection passages from a front surface side of the turret; and a rear-side fluid supply mechanism configured to supply fluid to the at least one of the rear-surface-side fluid connection passages from a rear surface side of the turret.

3) The tool post for machine tools according to the above-described aspect 2), wherein the turret has a rotation shaft which is hollow, and the front-side fluid supply mechanism includes: a multi-stage fluid distributor having a required number of fluid distribution passages and fixed to the tool post body so as to be positioned on a front side of the turret; fluid introduction pipes inserted in the rotation shaft and configured to introduce fluid to each of the fluid distribution passages, respectively, of the multi-stage fluid distributor; and a fluid communication member in which fluid communication passages having turret-side ends that respectively communicate with the front-surface-side fluid connection passages of the turret, and distributor-side ends that, when the turret stops at an indexing position, respectively communicate with the fluid distribution passages of the multi-stage fluid distributor, are formed, and the fluid communication member rotates integrally with the turret.

4) The tool post for machine tools according to the above-described aspect 3), wherein each of the fluid distribution passages of the multi-stage fluid distributor is disposed at a different position from one another in a circumferential direction of the rotation shaft; at portions of the fluid distribution passages of the multi-stage fluid distributor, which portions respectively facing the distributor-side ends of the fluid communication member, spools biased by elastic members are disposed slidably on edge portions of the distributor-side ends of the fluid communication member, respectively; and when the turret stops at the indexing position, the fluid is supplied to each of the front-surface-side fluid connection passages, through each of the fluid introduction pipes, each of the fluid distribution passages of the multi-stage fluid distributor, each of the spools, and each of the fluid communication passages of the fluid communication member, respectively.

5) The tool post for machine tools according to any one of the above-described aspects 2) to 4), wherein the rear-side fluid supply mechanism includes: a cylinder-piston mechanism which is provided to the tool post body and in which a piston is configured to be capable of moving forward and backward; a required number of piston-internal passages formed inside the piston, so as to have front ends on a side near the turret and rear ends on a side far from the turret; fluid introduction pipes configured to introduce fluid to the rear ends of the piston-internal passages, respectively; and joints configured to allow communication between the rear-surface-side fluid connection passages and the piston-internal passages, respectively, the joints consist of: turret-side joints fixed to the turret, so as to communicate with ends of the rear-surface-side fluid connection passages, respectively, the ends being located outside the tool holder mounting surface; and piston-side joints fixed to the piston, so as to communicate with the front ends of the piston-internal passages, respectively, and when the turret stops at an indexing position, the piston moves forward whereby the piston-side joints are connected to the turret-side joints, respectively, and when the turret rotates, the piston moves backward whereby the connection of the piston-side joints to the turret-side joints, respectively, is released.

### Advantageous Effects of Invention

In accordance with the tool post according to the above-described aspect 1), on each of the tool holder mounting surface, a plurality of fluid connection passages are provided in order to supply respective fluids (various types of fluids, such as hydraulic oil, air, and coolant). Therefore, it is possible to mount a plurality of actuators using the various types of fluids as a driving source and having various functions thereby providing a new function. In this tool post, because each of the fluid connection passages are open in the radial direction, it is possible to dispose the device and member that constitute the fluid supply mechanism, using not only the front surface side but also the rear surface side of the turret, whereby it is possible to avoid an increase in size of the tool post.

In accordance with the tool post for machine tools according to the above-described aspect 2), increasing the channels through which fluids are supplied is realized by supplying a plurality of fluids, from the front surface side of the turret and the rear surface side of the turret, to the front surface side and the rear surface side of the tool holder mounting surface of the turret. As such, in the tool post including the turret capable of mounting rotary tools (tool holders for rotary tools) which has not been conventionally realized, it is possible to obtain the advantageous effects of the above-described aspect 1). In this tool post, although it is possible to form, for example, six fluid channels by utilizing only the front-surface-side fluid connection passages and the front-side fluid supply mechanism, it is possible to avoid an increase in size of the tool post, by also utilizing the rear-surface-side fluid connection passages and rear-side fluid supply mechanism thereby forming three fluid channels on the front side and three fluid channels on the rear side, for example.

In accordance with the tool post for machine tools according to the above-described aspect 3), it is possible to obtain the front-side fluid supply mechanism configured to supply fluid from the front surface side of the turret to the front-surface-side fluid connection passages, without increasing the size of the tool post.

In accordance with the tool post for machine tools according to the above-described aspect 4), because a sealing mechanism between the multi-stage fluid distributor, which is on the fixed side, and the fluid communication member configured to rotate with respect to the multi-stage fluid distributor may be simplified, it is possible to avoid an increase in size of the tool post.

In accordance with the tool post for machine tools according to the above-described aspect 5), it is possible to obtain the rear-side fluid supply mechanism configured to supply fluid from the rear surface side of the turret to the rear-surface-side fluid connection passages, without increasing the size of the tool post.

### BRIEF DESCRIPTION OF THE DRAWINGS

FIG. 1 is a vertical cross-sectional view showing a tool post for machine tools according to one embodiment of the present invention.

FIG. 2 is a horizontal cross-sectional view showing the tool post, and is a cross-sectional view taken along the line II-II of FIG. 1.

FIG. 3 is a front view showing the tool post.

FIG. 4 is an enlarged vertical cross-sectional view showing a principal part of FIG. 1 in an enlarged manner.

FIG. 5 is an enlarged vertical cross-sectional view showing a principal part of FIG. 4 in an enlarged manner.

### DETAILED DESCRIPTION OF EMBODIMENTS

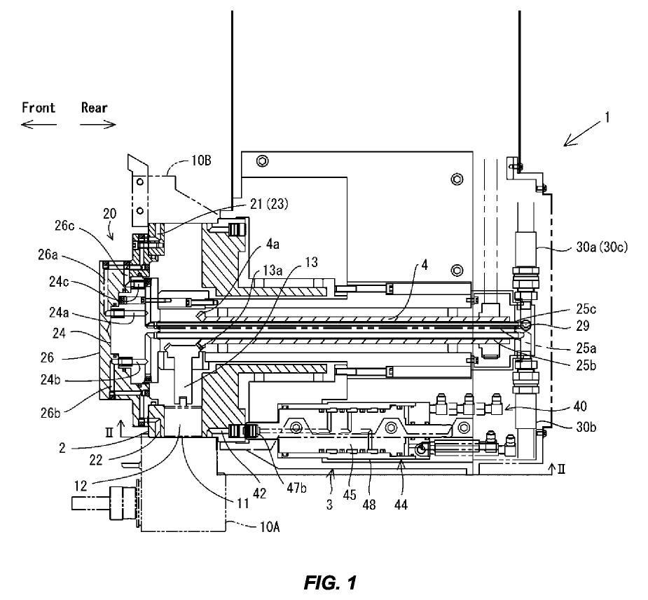

Hereinafter, referring to FIG. 1 to FIG. 5, a tool post for machine tools according to one embodiment of the present invention will be described. In this DESCRIPTION, regarding the front and rear sides, the left side of FIG. 1 is referred to as the front side and the right side of FIG. 1 is referred to as the rear side.

A tool post (1) includes: a turret (2) provided on an outer periphery thereof with a plurality of tool holder mounting surfaces (11) on which a plurality of types of tool holders (10A) and (10B) are mounted, the turret (2) configured to be indexed by rotation to a designated position; and a tool post body (3) configured to rotatably support the turret (2).

The tool post (1) is a tool post adapted for rotary (milling) tools, and a rotary drive shaft (12) for rotary tools, which is configured to rotate the tool holder (10A) for rotary tools, is disposed in the vicinity of the center of the tool holder mounting surface (11).

To the rotary drive shaft (12) for rotary tools, a distal end of a bevel gear shaft (13), which is provided on a proximal end thereof with a bevel gear (13a), is coupled, and the bevel gear (13a) of this bevel gear shaft (13) is engaged with a bevel gear (4a) provided on the front end of the rotation shaft (4).

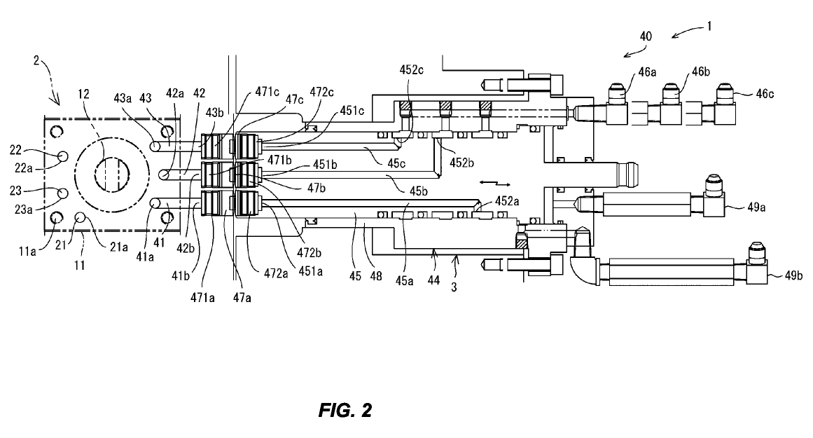

This tool post (1) is designed to be capable of mounting a multifunctional actuator that uses fluid as a driving source in order to realize process consolidation and automation, and therefore, as shown in FIG. 2, on each of the tool holder mounting surfaces (11) of the turret (2), one ends (21a), (22a), (23a), (41a), (42a), and (43a) of a plurality of fluid connection passages (21), (22), (23), (41), (42), and (43) configured to allow supply of fluid (various fluids, such as hydraulic oil, air, and coolant) that causes the actuator to drive are made open, and fluid supply mechanisms (20) and (40) configured to supply fluid to each of the fluid connection passages (21), (22), (23), (41), (42), and (43) are provided to the turret (2) and the tool post body (3).

In this embodiment, the plurality of fluid connection passages (21), (22), (23), (41), (42), and (43) consist of: a plurality of (three in FIG. 2, but the number is not limited thereto) front-surface-side fluid connection passages (21), (22), and (23) (specifically, a front-surface-side first connection passage (21), a front-surface-side second connection passage (22), and a front-surface-side third connection passage (23)); and a plurality of (three in FIG. 2, but the number is not limited thereto, and also, the number does not need to be identical to that for the front surface side) rear-surface-side fluid connection passages (41), (42), and (43) (specifically, a rear-surface-side first connection passage (41), a rear-surface-side second connection passage (42), and a rear-surface-side third connection passage (43)), where the front-surface-side fluid connection passages (21), (22), and (23) and the rear-surface-side fluid connection passages (41), (42), and (43) are respectively opposed to each other with the rotary drive shaft (12) for rotary tools interposed therebetween. In accordance with this configuration, provided are: a front-side fluid supply mechanism (20) configured to supply fluid to the three front-surface-side fluid connection passages (21), (22), and (23) from the front surface side of the turret (2); and a rear-side fluid supply mechanism (40) configured to supply fluid to the three rear-surface-side fluid connection passages (41), (42), and (43) from the rear surface side of the turret (2). At the four corners of the tool holder mounting surface (11), tool holder mounting holes (11a) are provided.

As shown in FIG. 1, the front-side fluid supply mechanism (20) includes: a multi-stage fluid distributor (24) fixed to the tool post body (3) so as to be positioned on a front side of the turret (2); fluid introduction pipes (25a), (25b), and (25c) configured to introduce fluid to the multi-stage fluid distributor (24); and a flange (fluid communication member) (26) that rotates integrally with the turret (2) to allow communication between the front-surface-side fluid connection passages (21), (22), and (23) of the turret (2) and the fluid distribution passages (24a), (24b), and (24c) of the multi-stage fluid distributor (24), respectively.

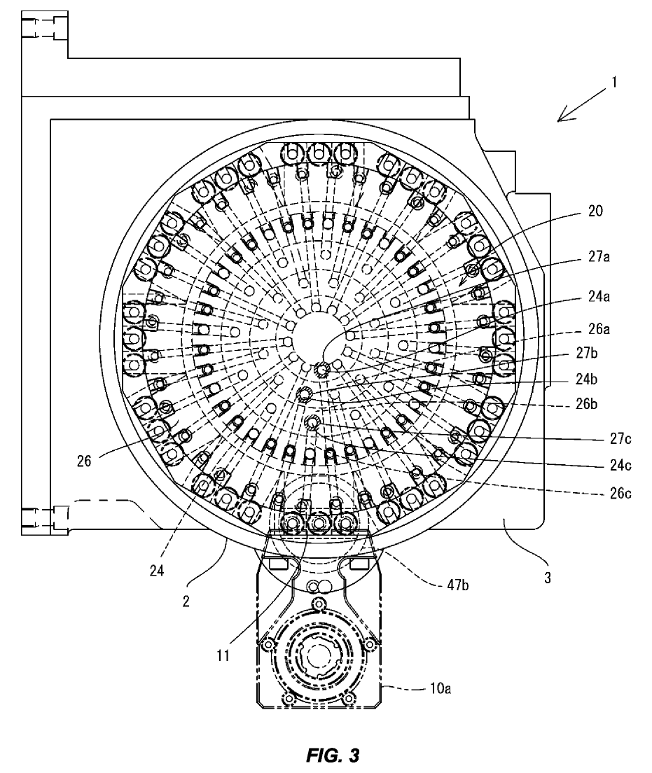

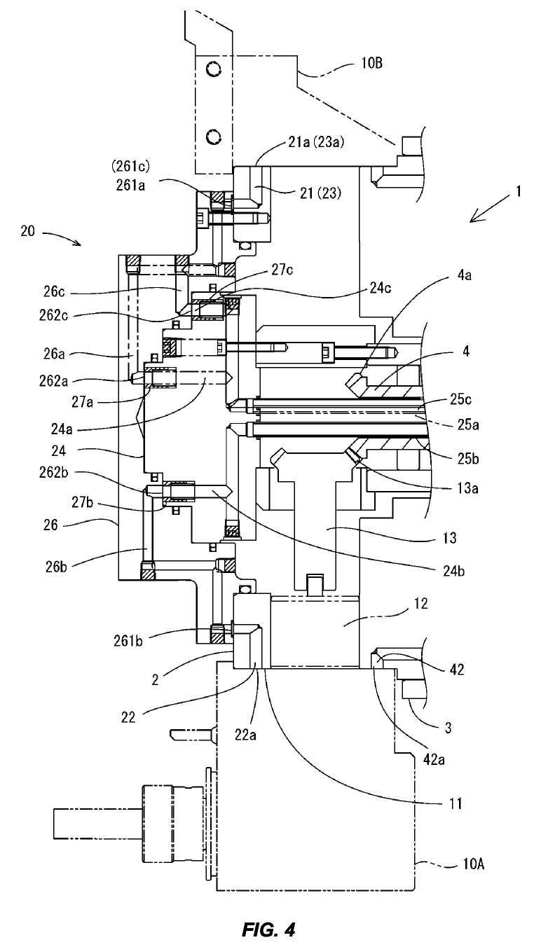

The multi-stage fluid distributor (24) is a three-stage type corresponding to the number of the front-surface-side fluid connection passages (21), (22), and (23), and has three fluid distribution passages (24a), (24b), and (24c) (specifically, a smallest-diameter distribution passage (24a), an intermediate-diameter distribution passage (24b), and a largest-diameter distribution passage(24c)). Although the fluid distribution passages (24a), (24b), and (24c) of the multi-stage fluid distributor (24) are provided so as to be offset in the circumferential direction from one another as shown in FIG. 3, they are depicted as being located at the same cross-sectional position in FIG. 1 and FIG. 4, for convenience. With regard to the front-surface-side fluid connection passages (21), (22), and (23) of the turret (2), the front-surface-side second connection passage (22) in communication with the intermediate-diameter distribution passage (24b) is shown in the lower portion of the drawings, and the front-surface-side first connection passage (21) and the front-surface-side third connection passage (23) in communication with the smallest-diameter distribution passage (24a) and the largest-diameter distribution passage (24c), respectively, are shown in the upper portion of the drawings in an overlapping manner.

As fluid introduction pipes (25a), (25b), and (25c), provided are three fluid introduction pipes (25a), (25b), and (25c) (specifically, a first introduction pipe (25a) located at the far side of the drawing sheet and shown by an alternate long and two short dashes line, a second introduction pipe (25b) located at a lower portion of the near side of the drawing sheet and shown by a solid line, and a third introduction pipe (25c) located at an upper portion of the near side of the drawing sheet and shown by a solid line). To accommodate these three fluid introduction pipes (25a), (25b), and (25c), the rotation shaft (4) of the tool post (1) is a hollow shaft.

Front ends of the fluid introduction pipes (25a), (25b), and (25c) are in communication with the fluid distribution passages (24a), (24b), and (24c) of the multi-stage fluid distributor (24), respectively. Rear ends of the fluid introduction pipes (25a), (25b), and (25c) are connected to fluid introduction hoses (30a), (30b), and (30c), respectively, via a passage block (29) in which communication passages (not shown) are provided.

The flange (26) is disposed so as to surround the multi-stage fluid distributor (24) from the front and from the radially inside and outside, and is fixed to the turret (2) such that the flange (26) is rotatable with respect to the multi-stage fluid distributor (24). The flange (26) is provided with fluid communication passages (26a), (26b), and (26c) that allow communication between the front-surface-side fluid connection passages (21), (22), and (23) of the turret (2), and the fluid distribution passages (24a), (24b), and (24c) of the multi-stage fluid distributor (24), respectively.

The fluid connection passages (21), (22), (23), (41), (42), and (43) of the turret (2), the fluid distribution passages (24a), (24b), and (24c) of the multi-stage fluid distributor (24), and the fluid communication passages (26a), (26b), and (26c) of the flange (26) may be obtained by providing drilled holes on respective block-shaped body portions from surface sides thereof, so as to form L-shaped passages, for example.

As shown in FIG. 4 in detail, the fluid communication passages (26a), (26b), and (26c) of the flange (26) consist of: a first fluid communication passage (26a) having a distributor-side end (262a) that communicates with the smallest-diameter distribution passage (24a) of the multi-stage fluid distributor (24) when a turret-side end (261a) in communication with the front-surface-side first connection passage (21) of the turret (2) and the turret (2) stop at an indexing position; a second fluid communication passage (26b) having a distributor-side end (262b) that communicates with the intermediate-diameter distribution passage (24b) of the multi-stage fluid distributor (24) when a turret-side end (261b) in communication with the front-surface-side second connection passage (22) of the turret (2) and the turret (2) stop at an indexing position; and a third fluid communication passage (26c) having a distributor-side end (262c) that communicates with the largest-diameter distribution passage(24c) of the multi-stage fluid distributor (24) when a turret-side end (261c) in communication with the front-surface-side third connection passage (23) of the turret (2) and the turret (2) stop at an indexing position.

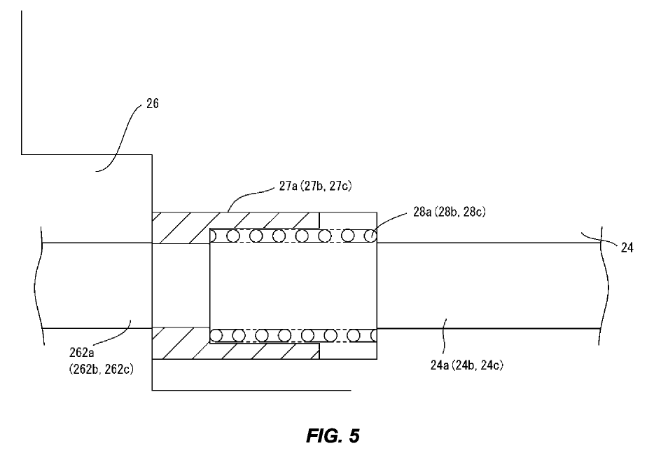

As shown in FIG. 5, at portions of the fluid distribution passages (24a), (24b), and (24c) of the multi-stage fluid distributor (24), which portions respectively facing the distributor-side ends (262a), (262b), and (262c) of the fluid communication member (26), spools (27a), (27b), and (27c) biased by springs (elastic members) (28a), (28b), and (28c) are disposed slidably on edge portions of the distributor-side ends (262a), (262b), and (262c) of the flange (26), respectively. The flange (26) integrated with (for example, fastened to) the turret (2) rotates with respect to the multi-stage fluid distributor (24) and slides in close contact with each of the spools (27a), (27b), and (27c). The spools (27a), (27b), and (27c) are constantly in contact with the flange (26), and at the indexing position, are biased by the springs (elastic members) (28a), (28b), and (28c) whereby fluid leakage is prevented.

With this configuration, in accordance with the front-side fluid supply mechanism (20) of the above-described embodiment, when the turret (2) stops at an indexing position, fluid having been supplied from each of the fluid introduction hoses (30a), (30b), and (30c) (three channels in the example shown in the drawings) is supplied, through the passage block (29), each of the fluid introduction pipes (25a), (25b), and (25c), each of the fluid distribution passages (24a), (24b), and (24c) of the multi-stage fluid distributor (24), each of the spools (27a), (27b), and (27c), and each of the fluid communication passages (26a), (26b), and (26c) of the flange (26), to the fluid connection passages (three channels in the example shown in the drawings) (21), (22), and (23) disposed on a front surface side of the tool holder mounting surface (11) of the turret (2). The fluid communication passages (26a), (26b), and (26c) of the flange (26) are provided in a number corresponding to the number of the tool holder mounting surfaces (11) of the turret (2), and when the turret (2) is indexed, fluid is caused to be supplied to only one of the tool holder mounting surface (11) that is in communication with one of the spools (27a), (27b), and (27c). Although fluid is generally supplied to a tool holder mounting surface (11) that is indexed at the time of machining, fluid may be supplied to an actuator mounted on a tool holder mounting surface (11) that is not indexed at the time of machining, which is achieved by changing the phase in which the spools (27a), (27b), and (27c) are mounted, thereby allowing the actuator to which fluid is thus supplied to perform conveyance, cleaning, machining assistance, and so on, for example.

As shown in FIG. 2, the rear-side fluid supply mechanism (40) includes: a cylinder-piston mechanism (44) which is provided to the tool post body (3) and in which a piston (45) is configured to be capable of moving forward and backward; three (which are equal in number to the number of the rear-surface-side fluid connection passages (41), (42), and (43)) piston-internal passages (45a), (45b), and (45c) formed inside the piston(45) (a first piston-internal passage (45a) in communication with the rear-surface-side first connection passage (41), a second piston-internal passage (45b) in communication with the rear-surface-side second connection passage (42), and a third piston-internal passage (45c) in communication with the rear-surface-side third connection passage (43)); fluid introduction pipes (46a), (46b), and (46c) configured to introduce fluid to the piston-internal passages (45a), (45b), and (45c), respectively; and couplers (joints) (47a), (47b), and (47c) that allow communication between the rear-surface-side fluid connection passage (41), (42), and (43) and the piston-internal passages (45a), (45b), and (45c), respectively.

The piston-internal passages (45a), (45b), and (45c) have: front ends (451a), (451b), and (451c) on a side near the turret (2); and rear ends (452a), (452b), and (452c) on a side far from the turret (2). The fluid introduction pipes (46a), (46b), and (46c) are configured to introduce fluid to the rear end (452a), (452b), and (452c) of the piston-internal passages (45a), (45b), and (45c), respectively.

The couplers (47a), (47b), (47c) consists of: turret-side couplers (joints) (471a), (471b), and (471c) fixed to a back surface portion of the turret (2) so as to communicate with ends (41b), (42b), and (43b), respectively, which are located outside the tool holder mounting surface (11) of the respective rear-surface-side fluid connection passages (41), (42), and (43); and piston-side couplers (joints) (472a), (472b), and (472c) fixed to the piston (45) so as to communicate with the front ends (451a), (451b), and (451c) of the respective piston-internal passages (45a), (45b), and (45c).

The piston (45) is housed within a cylinder (48) that is fastened to the tool post body (3) and performs a forward/backward movement by pressure supply, such as supply of hydraulic pressure and so on. The tool post body (3) is provided with a hydraulic hose (49a) configured to cause the piston (45) to move forward and a hydraulic hose (49b) configured to cause the piston (45) to move backward.

In accordance with the rear-side fluid supply mechanism (40) of the above-described embodiment, when the turret (2) stops at an indexing position (FIG. 2 shows this state), the piston (45) moves forward whereby the piston-side couplers (472a), (472b), and (472c) are connected to the turret-side couplers (471a), (471b), and (471c), respectively. As a result, fluid supplied from each of the fluid introduction pipes (46a), (46b), and (46c) are supplied, through the piston-internal passages (45a), (45b), and (45c), the piston-side couplers (472a), (472b), and (472c), and the turret-side couplers (471a), (471b), and (471c), to the rear-surface-side fluid connection passages (41), (42), and (43) disposed on the rear surface side of the tool holder mounting surface (11) of the turret (2).

And, when the turret (2) rotates, the piston (45) moves backward, and the connection of the piston-side couplers (472a), (472b), and (472c) to the turret-side couplers (471a), (471b), and (471c), respectively, is released, whereby the turret (2) becomes capable of turning to a next indexing position.

In accordance with the tool post (1) of the above-described embodiment, on each of the tool holder mounting surfaces (11) of the turret (2), one ends (21a), (22a), (23a), (41a), (42a), and (43a) of the plurality of fluid connection passages (21), (22), (23), (41), (42), and (43) configured to allow supply of fluid are made open, and the tool post body (3) is provided with the fluid supply mechanisms (20) and (40) configured to supply fluid to each of the fluid connection passages (21), (22), (23), (41), (42), and (43). With this configuration, for example, in a case where a gripper capable of opening/closing operation by hydraulic pressure or pneumatic pressure is mounted to the tool post (1), it becomes possible to grip and remove chips wound around the workpiece, and in a case where a workpiece handling mechanism capable of gripping the workpiece is mounted to the tool post (1), automation of attachment and detachment of the workpiece is facilitated. Further, in a case where a rotation mechanism is additionally provided to the workpiece handling mechanism, it becomes possible to continuously perform machining on both front and rear surfaces of the workpiece. In addition, it becomes possible to additionally provide a chatter suppression function to come into contact with and presses against a thin-walled or elongated workpiece in order to suppress machining chatter of such a workpiece. Furthermore, in a case where a clamping function to operate detachably mountable tools with hydraulic pressure or pneumatic pressure is additionally provided, it becomes possible to perform an ATC (Automatic Tool Change) operation in conjunction with a robot or the like.

The ATC function can be obtained as follows, for example. The functions on the tool post (1) side which are required for a conventional ATC operation for tools are: hydraulic pressure supply for tool clamping; hydraulic pressure supply for tool unclamping; air blow supply to the tool mounting surface at the time of mounting and removal of the tools; and air supply for seating confirmation by which tool clamping state is detected; through-type cutting fluid supply; and external-type cutting fluid supply. These six-channel fluids are supplied from the front-surface-side and rear-surface-side fluid connection passages (21), (22), (23), (41), (42), and (43) of the tool holder mounting surface (11) of the turret (2) to an automatic tool clamping unit thereby realizing the ATC operation for the tools.

It should be noted that tool posts generally come in two types. One type is a tool post dedicated to turning operations. The tool holder mounting surface of the turret of this type of tool post has only a tool holder mounting hole and a cutting fluid supply hole. In order to add fluid connection passages (21), (22), (23), (41), (42), and (43) of the above-described embodiment, relatively sufficient space is available, and the degree of freedom for its realization is high. The other type is a tool post (1) adapted for rotary tools as shown in the above-described embodiment. In this type of the tool post (1), in addition to the tool holder mounting hole and the cutting fluid supply hole, the rotary drive shaft (12) for rotary tools is disposed in the vicinity of the center of the tool holder mounting surface (11), and therefore, it is difficult to add the plurality of fluid connection passages (21), (22), (23), (41), (42), and (43) within limited space where the size of the turret has conventionally remained the same, which means there arise constraints, such as reducing the number of the fluid connection passages, reducing the diameter of the passage, and so on. The tool post (1) according to the above-described embodiment is characterized in that a plurality of fluids are supplied to the front surface side and the rear surface side of the tool holder mounting surface (11) of the turret (2), from the front surface side of the turret and the rear surface side of the turret, respectively, which allows for supply of a plurality of fluids while preventing interference with the rotary drive shaft (12) for rotary tools and without changing the conventional turret size.

It should be noted that although, in the above-described embodiment, fluids through six channels in total are designed to be supplied to the tool holder mounting surface, naturally, the number of the channels may be increased/decreased as appropriate, depending on space existing on the tool post, and other factors.

### REFERENCE SIGNS LIST

(1): tool post

(2): turret

(3): tool post body

(4): rotation shaft

(10A), (10B): tool holder

(10A): tool holder for rotary tools

(11): tool holder mounting surface

(12): rotary drive shaft for rotary tools

(20): front-side fluid supply mechanism

(21), (22), (23): front-surface-side fluid connection passage

(24): multi-stage fluid distributor

(24a), (24b), (24c): fluid distribution passage

(25a), (25b), (25c): fluid introduction pipe

(26): flange (fluid communication member)

(261a), (261b), (261c): turret-side end

(262a), (262b), (262c): distributor-side end

(26a), (26b), (26c): flange-internal passage (fluid communication passage)

(27a), (27b), (27c): spool

(28a), (28b), (28c): spring (elastic member)

(40): rear-side fluid supply mechanism

(41), (42), (43):rear-surface-side fluid connection passage

(41a), (42a), (43a): end that opens on the tool holder mounting surface

(41b), (42b), (43b): end located outside the tool holder mounting surface

(44): cylinder-piston mechanism

(45): piston

(45a), (45b), (45c): piston-internal passage

(451a), (451b), (451c): front end

(452a), (452b), (452c): rear end

(46a), (46b), (46c): fluid introduction pipe

(47a), (47b), (47c): coupler (joint)

(471a), (471b), (471c): turret-side coupler (joint)

(472a), (472b), (472c): piston-side coupler (joint)

1. A tool post for machine tools, the tool post comprising: a turret provided on an outer periphery thereof with a plurality of tool holder mounting surfaces on which a plurality of types of tool holders and are mounted, the turret configured to be indexed by rotation to a designated position; and a tool post body configured to rotatably support the turret,
the tool post characterized in that, on each of the tool holder mounting surfaces of the turret, one end of each of a plurality of fluid connection passages configured to allow supply of fluid is made open, and the turret and the tool post body are provided with fluid supply mechanisms and configured to supply the fluid to each of the fluid connection passages, and
an actuator, which uses the fluid supplied through each of the fluid connection passages as a driving source, is configured to be mountable on the turret.

2. The tool post for machine tools according to claim 1, wherein the tool post includes at least one tool holder for rotary tools, as the plurality of types of tool holders, and a rotary drive shaft for rotary tools is disposed in a vicinity of a center of the tool holder mounting surface for the tool holder for rotary tools,
the plurality of fluid connection passages consists of: at least one of front-surface-side fluid connection passages; and at least one of rear-surface-side fluid connection passages, where the front-surface-side fluid connection passages and the rear-surface-side fluid connection passages are respectively opposed to each other with the rotary drive shaft for rotary tools interposed therebetween, and
the fluid supply mechanisms consist of: a front-side fluid supply mechanism configured to supply fluid to the at least one of the front-surface-side fluid connection passages from a front surface side of the turret; and a rear-side fluid supply mechanism configured to supply fluid to the at least one of the rear-surface-side fluid connection passages from a rear surface side of the turret.

3. The tool post for machine tools according to claim 2, wherein the turret has a rotation shaft which is hollow, and
the front-side fluid supply mechanism comprises: a multi-stage fluid distributor having a required number of fluid distribution passages and fixed to the tool post body so as to be positioned on a front side of the turret; fluid introduction pipes inserted in the rotation shaft and configured to introduce fluid to each of the fluid distribution passages, respectively, of the multi-stage fluid distributor; and a fluid communication member in which fluid communication passages having turret-side ends that respectively communicate with the front-surface-side fluid connection passages of the turret, and distributor-side ends that, when the turret stops at an indexing position, respectively communicate with the fluid distribution passages of the multi-stage fluid distributor, are formed, and the fluid communication member rotates integrally with the turret.

4. The tool post for machine tools according to claim 3, wherein each of the fluid distribution passages of the multi-stage fluid distributor is disposed at a different position from one another in a circumferential direction of the rotation shaft; at portions of the fluid distribution passages of the multi-stage fluid distributor, which portions respectively facing the distributor-side ends of the fluid communication member, spools biased by respective elastic members are disposed slidably on edge portions of the distributor-side ends of the fluid communication member, respectively; and when the turret stops at the indexing position, the fluid is supplied to each of the front-surface-side fluid connection passages, through each of the fluid introduction pipes, each of the fluid distribution passages of the multi-stage fluid distributor, each of the spools, and each of the fluid communication passages of the fluid communication member, respectively.

5. The tool post for machine tools according to claim 2, wherein the rear-side fluid supply mechanism comprises: a cylinder-piston mechanism which is provided to the tool post body and in which a piston is configured to be capable of moving forward and backward; a required number of piston-internal passages formed inside the piston, so as to have front ends on a side near the turret and rear ends on a side far from the turret; fluid introduction pipes configured to introduce fluid to the rear ends of the piston-internal passages, respectively; and joints configured to allow communication between the rear-surface-side fluid connection passages and the piston-internal passages, respectively,
the joints consist of: turret-side joints fixed to the turret, so as to communicate with ends of the rear-surface-side fluid connection passages, respectively, the ends being located outside the tool holder mounting surface; and piston-side joints fixed to the piston, so as to communicate with the front ends of the piston-internal passages, respectively, and
when the turret stops at an indexing position, the piston moves forward whereby the piston-side joints are connected to the turret-side joints, respectively, and when the turret rotates, the piston moves backward whereby the connection of the piston-side joints to the turret-side joints, respectively, is released.
